(19) United States
(12) Patent Application Publication
(10) Pub. No.: US 2022/0143703 A1
(43) Pub. Date: May 12, 2022

(54) MATERIAL REMOVAL SYSTEM

(71) Applicant: HEWLETT-PACKARD DEVELOPMENT COMPANY, L.P., Spring, TX (US)

(72) Inventors: David CHANCLON FERNANDEZ, Sant Cugat del Valles (ES); Sergio MIGUELEZ CAMPILLO, Sant Cugat del Valles (ES); Jorge DIOSDADO BORREGO, Sant Cugat del Valles (ES)

(21) Appl. No.: 17/433,947

(22) PCT Filed: Apr. 30, 2019
(86) PCT No.: PCT/US2019/030009

§ 371 Date: Aug. 25, 2021

(51) Int. Cl. B22F 10/68; B33Y 40/20; B33Y 50/00; B22F 10/80; B22F 12/90; B08B 5/02; B08B 7/02; B08B 7/04; B08B 13/00; B29C 64/35

(52) U.S. Cl. CPC B22F 10/68; B33Y 40/20; B33Y 50/00; B22F 10/80; B29C 64/35; B08B 5/02; B08B 7/02; B08B 7/04; B08B 13/00; B22F 12/90

(57) ABSTRACT

A three-dimensional printer is described, wherein the three-dimensional printer comprises a build unit and a material removal unit. The build unit is configured to generate a three dimensional object. The material removal unit comprises a housing, a plurality of gas inlets and outlets, a plurality of valves and a control unit. The housing is sealed to the build unit and is configured to house a cake comprising the generated three dimensional object. The valves are configured to open and close the inlets and outlets, and the control unit is configured to control the valves, to allow gas to flow from different inlets to different outlets in different flow paths, in order remove powder from the object.

### BACKGROUND

A three-dimensional printer may generate a three-dimensional object by printing a plurality of successive two-dimensional layers on top of one another. In some three-dimensional printing systems, each layer of an object may be formed by placing a uniform layer of build material in the printer's build bed and then placing an agent at specific points at which it is desired to solidify the build material to from the layer of the object. After the layer has solidified, a further layer of build material is applied to the previous layer and agent is placed at the specific points at which it is desired to solidify the powder of that layer.

When all the layers of the three-dimensional object have been solidified, there is provided a cake formed of the solidified three-dimensional object within the residual build material that has not been solidified. The residual powder may be the powder in each layer to which the agent has not been applied. The three-dimensional object may then be removed from the powder.

### BRIEF DESCRIPTION OF THE DRAWINGS

FIG. 1 is an illustration of an example of a material removal system;

FIG. 2 is an illustration of a side view of the material removal system of the example of FIG. 1;

FIG. 3 is an illustration of a section view of the material removal system of the example of FIG. 1;

FIG. 4 is an illustration of a top view the material removal system, of the example of FIG. 1;

FIG. 5 is a flow chart of an example material removal method;

FIG. 6 is a flow chart of an example method for adjusting a flow path;

FIG. 7 is a flow chart of an example method for adjusting a flow path; and

FIG. 8 is a block diagram of an example of a machine readable medium in association with a processor.

### DETAILED DESCRIPTION

In three-dimensional printing, one or more three-dimensional objects may be generated by solidifying a build material, which may be a powder. In some examples, the build material may be formed from, or may include, short fibres that may, for example, have been cut into short lengths from long strands or threads of material. The build material may comprise plastics, ceramic or metal powders or powder-like material.

In a method, a fusing agent may be distributed over a layer of powdered build material in a predetermined pattern, and heat may be applied to the layer of build material such that portions of the layer on which fusing agent is applied heat up, coalesce, and then solidify upon cooling, thereby forming a layer of the object. Portions of the layer of build material on which no fusing agent is applied do not heat sufficiently to coalesce and solidify. The generated three-dimensional objects may then undergo a cleaning process, to remove the portions of the unfused build material.

In another method, a binding agent may be distributed over a layer of powdered metal build material in a predetermined pattern to solidify the portions of powder to which the binding agent has been applied. A curing process may then strengthen the solidified portion of the powder. The generated cake may then undergo a cleaning process, to remove the unbound powder from the generated three-dimensional object. After the unbound powder has been removed, the three-dimensional object may be sintered, to fuse the metal particles.

The cleaning process may comprise a first, coarse cleaning, and a second, fine cleaning. The coarse cleaning may comprise removing a majority of powder material from around the generated three-dimensional object. The fine cleaning may comprise removing the remaining material that may be in contact with a surface of the three-dimensional object.

Examples described herein allow unfused or unbound build material to be removed from a cake to provide a cleaned generated object. As described below, this may be achieved by providing an automated means for generating a plurality of gas flow paths around the generated object. Examples described herein may relate to the coarse cleaning process.

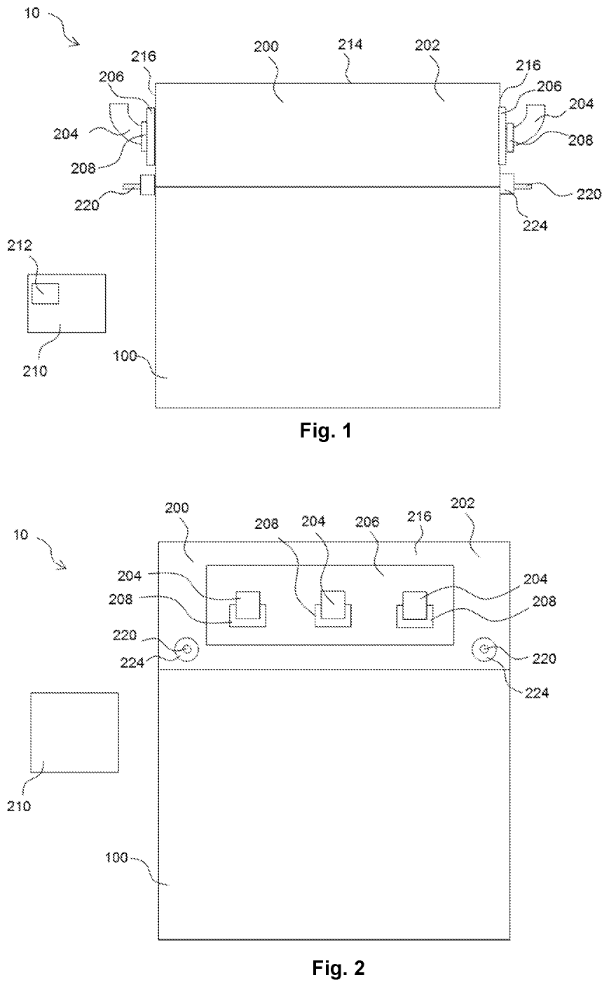

FIGS. 1 to 4 show an example of a material removal system 10 comprising a build unit 100 and a material removing unit 200. In some examples, the build unit 100 may be removable from the material removal system 10. In other examples, the build unit may be fixed in the material removal system 10.

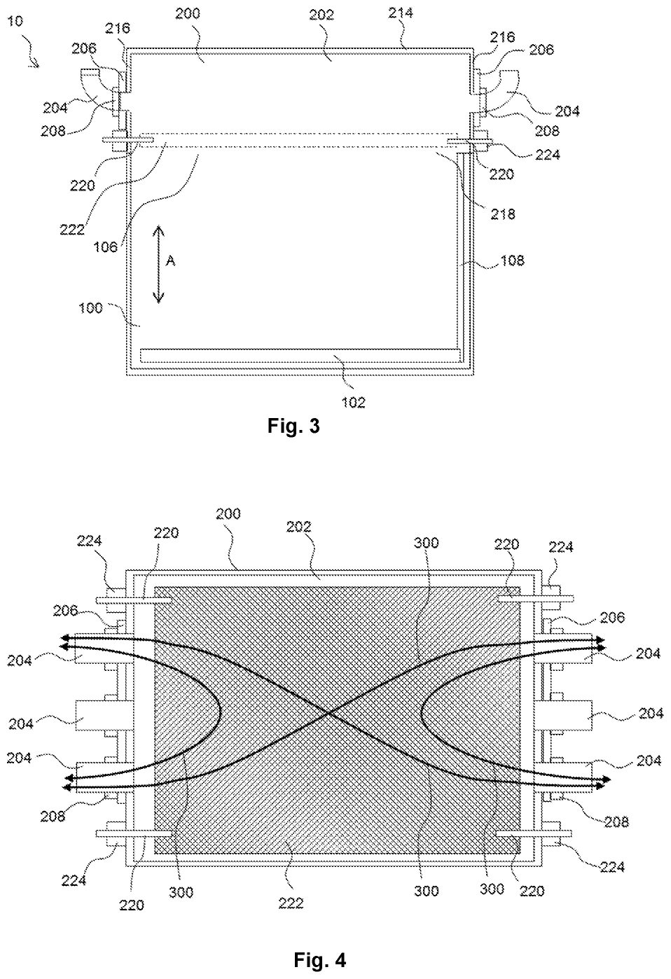

The material removing unit 200 comprises a housing 202 configured to house a cake comprising the generated three-dimensional object. A plurality of gas inlets and outlets 204 are provided in the housing 202. For example, a manifold 206 of gas inlets and outlets 204 as shown in FIG. 2 may be provided in a wall of the housing 202. The material removing unit 200 may comprise a plurality of manifolds 206. For example, first and second manifolds 206 may be provided in opposing walls of the housing 202, as shown in FIG. 3.

The three-dimensional object may be generated in the build unit 100 by a three-dimensional printer. In an example, the generated three-dimensional object may be generated by forming successive layers by applying a binding agent to selected regions of a layer of metal powder build material and the curing the bound parts formed of the successive layers. The powder to be removed from the three-dimensional object may be unbound metal powder. The housing may be configured to receive a cake formed of the three-dimensional object within the unbound powder build material.

In another example, the generated three-dimensional object may be formed of successive layers printed by applying a fusing agent to a powder build material and applying heat to the build material such that the portions of the build material do which fusing agent has been applied heat up, coalesce, and then solidify upon cooling. The housing may be configured to receive a cake formed of the three-dimensional object within the unfused powder build material. The powder to be removed from the generated three-dimensional object may be unfused powder build material.

The gas inlets and outlets 204 each comprise a valve 208, for example a pneumatic valve, for actuating the respective inlet or outlet. The plurality of gas inlets and outlets may be connectable, via the valves to a source of gas, for example compressed air. The plurality of gas inlets and outlets may be connectable to a negative pressure source, for example a vacuum source. The valves 208 may be configured to control the gas inlets and outlets 204 such that each inlet and outlet 204 can selectively act as an inlet or an outlet or can be closed.

The material removing unit 200 comprises a control unit 210, as shown in FIGS. 1 and 2. The control unit 210 is not shown in FIG. 3. The control unit is configured to actuate the plurality valves 208, to prevent or allow gas to flow through the housing 202 to remove powdered build material from the cake containing the three-dimensional object. The control unit 210 is configured to selectively actuate the valves 208. This may allow a plurality of different flow paths 300 of gas through the housing 202, as shown in FIG. 4. For example, opening a first inlet and a first outlet may allow gas to flow through the housing in a first path, and opening a second inlet and a second outlet may allow gas to flow through the housing in a second path, different to the first path. Opening and closing the inlets and outlets 204 in different combinations may allow different flow paths to be generated through the housing 202.

The generation of a plurality of different flow paths within the housing 202 may maximise the volume of the housing 200 through which gas passes to remove powder. This may ensure that powder can be removed from different regions of the generated object and may allow gas to target different areas of the cake. This may minimise operator intervention in the cleaning process and thereby reduce chance of an operator breaking the generated object.

In use, when gas flows onto the cake, powder may be loosened. Some of this loosened powder may flow through a gas outlet. Some of this loosened powder may fall, due to gravity, away from the generated object. The material removal system 10 may comprise a first collector (not shown) for collecting powder that falls due to gravity and may comprise a second collector (not shown) for collecting powder that flows through the outlets. In an example, the build unit 100 may comprise the first collector. The first collector may be configured to filter the powder from the gas flowing through the outlets. The material removal system 10 may comprise a recycling system (not shown) to recycle the collected powder, for example for use in a subsequent build process.

The valves 208 may be configured to control the velocity of gas flowing through the housing 202. The velocity may be controlled by controlling the pressure differential between the gas/vacuum source and the housing 202. The velocity of the gas flowing through the housing may be sufficiently high to loosen powder, whilst sufficiently low that abrasion of powder on the printed part is reduced and the amount of powder entrained in the air is reduced. The velocity of gas flowing through the housing may be less than 10 ms⁻¹, for example 5-6 ms⁻¹. Metal powder is particularly abrasive and erosion of the generated object by powder can impact on quality and tolerances of the generated object.

The control unit 210 may be configured to control operation of the valves 208 in a predetermined sequence. The material removing unit 200 may thereby generate a plurality of different flow paths in a predetermined sequence. The sequence may comprise a plurality of stages. The control unit 210 may be configured to selectively open and close valves 208 according to a first stage of the predetermined sequence, and after a predetermined amount of time, the control unit 210 may be configured to selectively open and close valves in a combination according to a second stage of the predetermined sequence.

The control unit 210 may be configured to control actuation of the valves 208 according to a user input. The material removing unit 200 may comprise a user interface 212 for receiving a user input to select a valve 208 to open or close, or to select a flow path from among a plurality of possible flow paths.

The material removing unit 200 may comprise an imaging sensor (not shown), for example a camera, configured to generate an image of the cake while the powder is being removed. The control unit 210 may be configured to determined, based on the generated image, a target location within the housing 202. The control unit 210 may be configured to control the valves such that a flow path is directed to the target location.

In another example, the user interface 212 may be configured to receive a user input to select a flow path to be directed to the target location based on the generated image.

The material removing unit 200 may comprise a fan (not shown) configured to direct powder away from a lens of the camera.

The build unit may comprise a build platform 102 and a powder supply unit (not shown) for providing a layer of powder on the build platform 102 to form the print bed. The build unit 100 may be receivable in a three-dimensional printer. In generating the three-dimensional object, a carriage of the printer may comprise a print head for depositing an agent onto a layer of powder formed on the build platform 102.

The housing 202 may be configured to be attached, for example sealed, to the build unit 100. The housing 202 may comprise an upper surface 214 and side walls 216, and may be open at a lower end 218. The upper surface 214 of the housing 202 is not present in FIG. 4. In use, the housing 202 may be attached to an upper surface of the build unit 100, where the upper surface of the build unit 100 comprises an opening 106. The build unit 100 may be configured to move the cake comprising the generated part within the powder from the interior of the build unit 100 to the material removing unit 200 through the opening 106 in the build unit 100. The powder used as the build material may be harmful to humans if inhaled, and the housing 102 being sealed to the build unit 100 may inhibit powder entering the environment outside of the material removal system 10 when the cake comprising the generated object is moved from the build unit 100 to the material removing unit 200.

The material removal system 10 may comprise a mechanism 108 for moving the cake comprising the generated object from the build unit 100 to the housing 202 of the material removing unit 200, through the opening 106 of the build unit 100 and open lower end of the housing 202, into the housing. For example, the mechanism 108 may be configured to move the build platform 102 upwards, in a direction shown by arrow A in FIG. 3, through the build unit 100 into the housing 202 of the material removing unit 200. The material removal system 10 may be configured to automatically move the cake comprising the generated object from the build unit 100 to the material removing unit 200 after the object has been generated in the build unit 100. This may reduce operator intervention in the material removal process. In the printing of metal parts by binding and curing metal powder, after curing the generated object may have relatively low strength and so may be easily broken by an operator; reducing operator intervention in the material removal process may reduce the risk of an operator breaking the object.

The material removing unit 200 may comprise a securing mechanism for retaining the cake comprising the generated object in the housing 202. The securing mechanism may comprise one or more mechanical fasteners 220 that retain the cake in the housing 202. The mechanical fasteners 220 may be screws. When the securing mechanism retains the cake within the housing, the build platform may move downwards, towards a base of the build unit, leaving the cake suspended by the securing mechanism within the housing.

The object may be generated on a supporting structure, for example a mesh 222, and the mechanical fasteners may hold the supporting structure within the housing 202, for example at corners of the supporting structure. The cake may be supported on the mesh 222. The mesh may be a metal mesh, for example formed of stainless steel. In use, the mesh 222 may be provided on the build platform 102, before the printing process, and the cake comprising the three-dimensional object may be generated on the mesh. The mesh may comprise openings for the flow of gas through the mesh to remove the powder and for the powder to fall through the mesh.

The material removing unit 200 may comprise a vibration mechanism 224. The vibration mechanism 224 may be configured to vibrate the cake, so that powder is loosened and falls away from the object. In an example, the vibration mechanism 224 may be part of the securing mechanism. In an example, wherein the object is generated on the mesh 222 and is suspended in the housing, the loosened powder may fall through the mesh when the cake is vibrated and the loosened powder may fall towards the build platform 102. The vibration mechanism may be configured to vary the amplitude and/or frequency of the vibration. The control unit may be configured to control the amplitude and/or frequency of the vibration generated by the vibration mechanism.

The first collector may be configured to collect the powder that is loosened by the vibrations and falls towards the build platform.

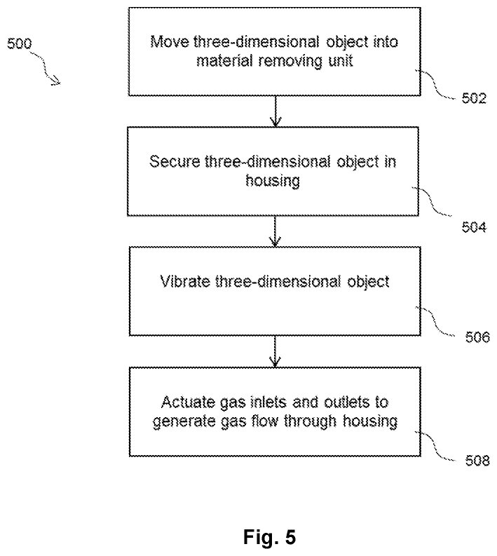

An example method 500 of removing powder from a generated three-dimensional object is shown in FIG. 5. The method may be implemented by the material removal system 10 shown in FIGS. 1-4. Prior to the method 500, a three-dimensional object may be generated in a three-dimensional printer by a printing process. The three-dimensional object may be an object formed through forming layers of fused powder, or may be formed by binding layers of metal powder and curing the bound layers. The cake comprising the generated three-dimensional object may be moved into a housing of a material removing unit at block 502. The cake may be secured in the housing at block 504. A mesh may support the cake and the mesh may be secured to the housing by mechanical fasteners. The cake may be moved, for example vibrated, at block 506 to loosen powder from the object. This may cause powder to fall from the printed object, for example onto the build platform of the build unit, and the fallen powder may be collected.

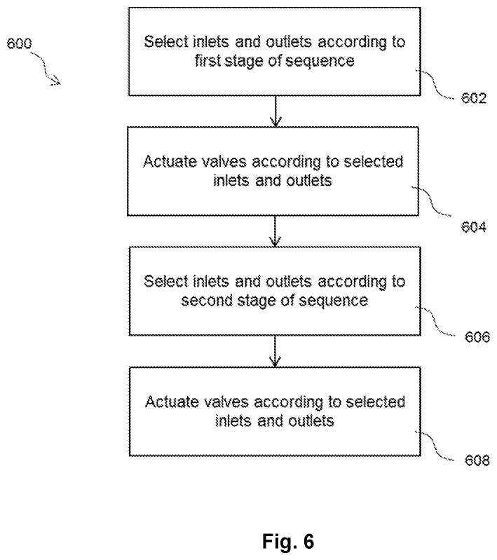

The plurality of gas inlets and outlets in the housing are actuated at block 508 to allow gas to flow through the housing. The gas flows in a plurality of different flow paths to remove powder from the three-dimensional object. The control unit may control a plurality of valves to selectively open and close the gas inlets and outlets to generate the different flow paths. FIG. 6 shows an example method 600 of controlling the plurality of valves to generate different flow paths.

In an example, the cake comprising the three-dimensional object may be vibrated at the same time as gas flows through the housing in the different flow paths.

The controlling the plurality of valves to selectively open and close the gas inlets and outlets may comprise controlling the valves in a predetermined sequence. This may generate a predetermined sequence of gas flow paths through the housing.

As shown in FIG. 6, the inlets and outlets to be opened, and the inlets and outlets to be closed, from among the plurality of inlets and outlets may be selected according to a first stage of a predetermined sequence, in block 602. The valves of the inlets and outlets may then be actuated according to the selected inlets and outlets that are to be opened or closed, thereby forming one or more first paths of gas through the housing in block 604.

The inlets and outlets to be opened, and the inlets and outlets to be closed, from among the plurality of inlets and outlets may then be selected according to a second stage of a predetermined sequence, in block 606. The valves of the inlets and outlets may then be actuated according to the selected inlets and outlets that are to be opened or closed, thereby forming one or more second paths of gas through the housing in block 608.

The method in blocks 606 and 608 may be repeated according to further stages in the predetermined sequence.

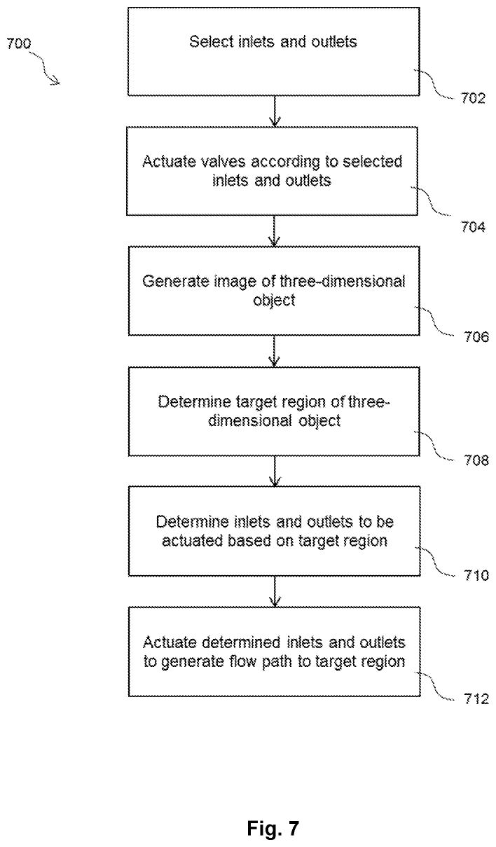

Another example method 700 of controlling the plurality of valves to generate different flow paths is shown in FIG. 7. The inlets and outlets to be opened, and the inlets and outlets to be closed, from among the plurality of inlets and outlets may be selected in block 702. The valves of the inlets and outlets may then be actuated according to the selected inlets and outlets that are to be opened or closed, thereby forming one or more first paths of gas through the housing in block 704.

An image of the cake comprising the three-dimensional object may be generated at block 706. For example, the image may be generated by a camera provided in the material removal system. The image may be analysed at block 708 to determine a region on the object at which a large amount of powder is situated. For example, the image may be analysed to determine a region in the housing where a density of powder is over a predetermined threshold. In an example, a plurality of regions on the object may be determined. The analysing the image may be an automated process, carried out by the control unit, for example. In another example, the analysing the image may be performed by a human operator. The determined region may be a target region, to which it may be desirable to target gas flow paths in order to remove the powder at that target region.

The inlets and outlets to be opened and the inlets and outlets to be closed, from among the plurality of outlets may then be determined according to the determined target region in the housing at block 710. The determined outlets may be opened and closed at block 712, to generate a gas flow path to target the determined region. Determining the inlets and outlets to be opened or closed according to the determined region may comprise determining a flow path from among a plurality of flow paths that will target the determined region, and determining the inlets and outlets to be opened or closed to generate that flow path. The control unit may be configured to determine the flow path based on the determined region. In another example, an operator may determine the flow path, and the method may comprise inputting the determined flow path into a user interface.

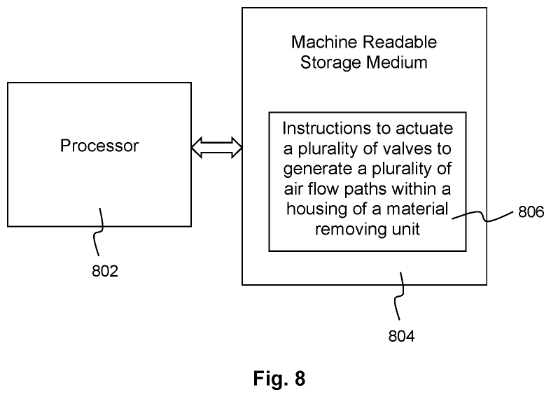

Various elements and features of the methods described herein may be implemented through the execution of machine-readable instructions by a processor. FIG. 8 shows a processing system comprising a processor 802 in association with a non-transitory machine-readable storage medium 804. The machine-readable storage medium may be a tangible storage medium, such as a removable storage unit or a hard disk installed in a hard disk drive. The machine-readable storage medium 804 comprises instructions at box 806 to actuate a plurality of valves to generate a plurality of air flow paths within a housing of a material removing unit.

The instructions to actuate the plurality of valves may comprise instructions to actuate the plurality of valves in a predetermined sequence.

According to the examples described herein, a plurality of flow paths may be generated to cover the volume of the housing, thereby directing gas to remove powder from different regions of the generated three-dimensional object in the housing. This may permit the removal of powder without requiring human intervention. This may minimise the risk of breakage of the generated three-dimensional object and may improve safety.

1. A material removal system comprising a material removing unit, wherein the material removing unit comprises:
a housing configured to house a cake comprising a three-dimensional object generated by a printing process;
a plurality of gas inlets and outlets provided in the housing, wherein the plurality of gas inlets and outlets each comprise a valve for actuating the respective inlet or outlet;
a control unit for controlling the plurality of valves to allow gas to flow through the housing to remove powdered build material from the cake comprising the three-dimensional object;
wherein the control unit is configured to selectively actuate the valves to allow gas to flow through the housing in a plurality of different flow paths.

2. A material removal system in accordance with claim 1, wherein the material removing unit comprises a securing mechanism configured to secure the object within the housing.

3. A material removal system in accordance with claim 2, wherein the securing mechanism is configured to suspend the object within the housing.

4. A material removal system in accordance with claim 1, wherein the material removing unit comprises a vibration mechanism configured to vibrate the object.

5. A material removal system in accordance with claim 1, wherein the control unit is configured to actuate the valves in a predetermined sequence to generate different flow paths through the housing.

6. A material removal system in accordance with claim 1, comprising an imaging sensor configured to generate an image of the object, wherein the control unit is configured to receive the image from the imaging sensor, determine a location of powder on the object, and actuate the valves to adjust a flow path to the determined location.

7. A material removal system in accordance with claim 1, comprising a build unit configured to generate a three-dimensional object,
wherein the housing of the material removing unit is sealed to the build unit.

8. A material removal system in accordance with claim 7, wherein the housing is sealed to an upper end of the build unit, and wherein the build unit comprises a platform for moving the object from the build unit to the housing.

9. A method comprising:
applying a gas flow through a plurality of gas inlets and outlets in a housing containing a cake comprising a three-dimensional object generated through a printing process,
wherein applying the gas flow comprises generating a plurality of different flow paths within the material removing unit to remove powdered build material from the three-dimensional object.

10. A method in accordance with the method of claim 9, comprising vibrating the cake to loosen powdered build material from the object.

11. A method in accordance with the method of claim 10, comprising collecting the loosened powdered build material.

12. A method in accordance with the method of claim 9, comprising generating the plurality of different flow paths in a predetermined sequence.

13. A method in accordance with the method of claim 9, comprising determining a location of the object at which powder is built up, and adjusting the flow paths within the material removing unit so that gas flows to the determined location.

14. A non-transitory machine-readable storage medium encoded with instructions executable by a processor, the machine-readable storage medium comprising:
instructions to actuate a plurality of valves to generate a plurality of air flow paths within a housing of a material removal apparatus.

15. A non-transitory machine-readable storage in accordance with claim 14, wherein the instructions to actuate the plurality of valves comprise instructions to actuate the plurality of valves in a predetermined sequence.
